(19) United States
(12) Patent Application Publication
(10) Pub. No.: US 2009/0015657 A1
(43) Pub. Date: Jan. 15, 2009

(54) METHOD AND SYSTEM FOR ADAPTING VIDEO ACCORDING TO ASSOCIATED AUDIO

(76) Inventor: Jason Wong, Vancouver (CA)

Correspondence Address: MCANDREWS HELD & MALLOY, LTD, 500 WEST MADISON STREET, SUITE 3400, CHICAGO, IL, 60661, US

(21) Appl. No.: 11/775,032

(22) Filed: Jul. 9, 2007

(51) Int. Cl. H04N 7/14

(52) U.S. Cl. 348/14.08; 348/E07.083

(57) ABSTRACT

The disclosed systems and methods relate to adapting video signals that may be suitable for video conference calling applications. Aspects of the present invention may improve visual perception at the client side with no change to the transmission side. Other aspects of the present invention may also minimize required transmission bandwidth while improving visual perception at the client side. Bandwidth may be saved by adapting the video coding techniques applied to video feeds from two or more callers.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Video conferencing with multiple video feeds may cause a viewer to search for the video feed with the main speaker or dominate voice. The viewer may have difficulty following conversations during video conferences with more than one speaking party. This has driven customers away from using video conference calling services.

Moreover, wireless service providers that provide video conferencing capability may be further limited by the display size of wireless devices. A small display with multiple video feeds may result in confusion for the viewer. Wireless service providers may also be limited by the availability of sufficient transmission bandwidth.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for adapting video according to associated audio as shown in and/or described in connection with at least one of the figures, as set forth more completely in the claims. Advantages, aspects and novel features of the present invention, as well as details of an illustrated embodiment thereof, will be more fully understood from the following description and drawings.

### BRIEF DESCRIPTION OF THE DRAWINGS

FIG. 1 is a flowchart illustrating an exemplary method for adapting video content in accordance with a representative embodiment of the present invention;

FIG. 2 is an illustration of an exemplary system for adapting video content in accordance with a representative embodiment of the present invention; and

FIG. 3 is another illustration of an exemplary system for adapting video content in accordance with a representative embodiment of the present invention.

### DETAILED DESCRIPTION OF THE INVENTION

Aspects of the present invention relate to adapting video signals that may be suitable for video conference calling applications. Aspects of the present invention may improve visual perception at the client side with no change to the transmission side. Other aspects of the present invention may also minimize required transmission bandwidth while improving visual perception at the client side. Bandwidth may be saved by adapting the video coding techniques applied to video feeds from two or more callers.

Although the following description may refer to particular network schemes and media standards, many other schemes and standards may also use these systems and methods.

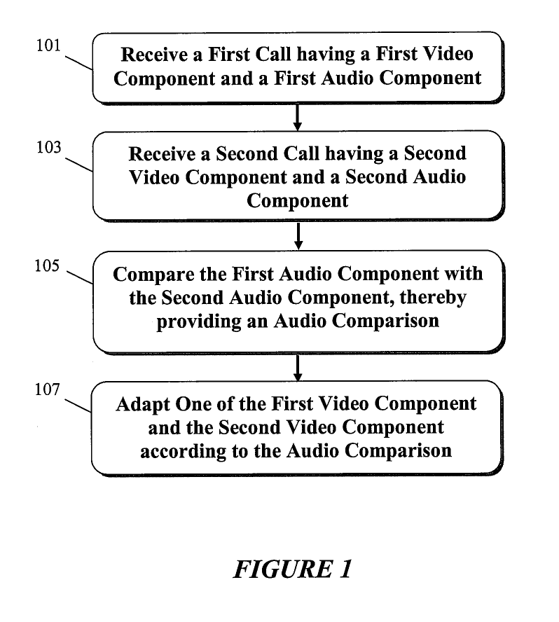

FIG. 1 is a flowchart illustrating an exemplary method for adapting video content in accordance with a representative embodiment of the present invention.

In a video conferencing scenario of three or more people including the user, there would be minimum two windows providing a video feed of the people in conversation. A user would receive a first call having a first video component and a first audio component at 101; and a second call having a second video component and a second audio component at 103.

The first audio component is compared to the second audio component to provide an audio comparison at 105.

Depending on the audio comparison, either one or both of the video components are altered at 107. The audio comparison may provide an indication of the dominate voice. Based on the detection of the dominate voice, the video feed windows on all calls that are non-dominating may be gradually blurred. Alternatively or in conjunction with blurring, the video feed window of the dominate voice caller may be sharpened.

Adapting the video according to the audio may indicate to the user which video feed to focus on and ease the complexity of determining the main speaker at any given moment of time. The adapted video may provide real-time feedback to the user on which video feed to focus upon in a scenario where two or more video feeds are present. This may mirror a natural human reaction to make eye contact with the current speaker in a conversation of two or more people.

Video may be adapted prior to a transmission in order to improve bandwidth utilization. The video signal associated with the dominant voice may utilize a higher bandwidth as compared to the other video signal(s).

User feedback may also be provided through a visual icon indicating the video feed with the dominate voice in a video conference scenario with multiple video feeds.

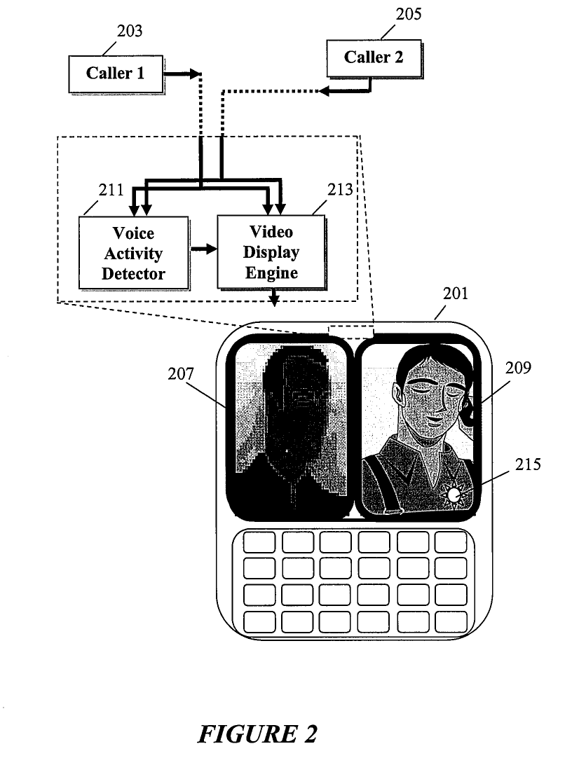

FIG. 2 is an illustration of an exemplary system for adapting video content in accordance with a representative embodiment of the present invention.

A voice activity detector, 211, receives audio signals from a first caller, 203, and a second caller, 205. The voice activity detector, 211, compares the strength of the first caller's audio signal and the second caller's audio signal, thereby creating an audio strength comparison. The audio strength comparison may be a determination of whether the first caller, 203, or the second caller, 205, is a dominant speaker at a particular time.

A video processing circuit, such as a video display engine, 213, adapts either one or both of the callers' video signals according to the audio strength comparison. Adaptation may be a visual degradation or a visual enhancement. For example, a video signal not associated with the dominant speaker may be degraded; or a video signal associated with the dominant speaker may be enhanced.

The video display engine, 213, may enable a simultaneous display of the first video signal, 207, and the second video signal, 209, on a user device, 201.

The video signal associated with the dominant speaker may also be identified by any other visual indicator, 215.

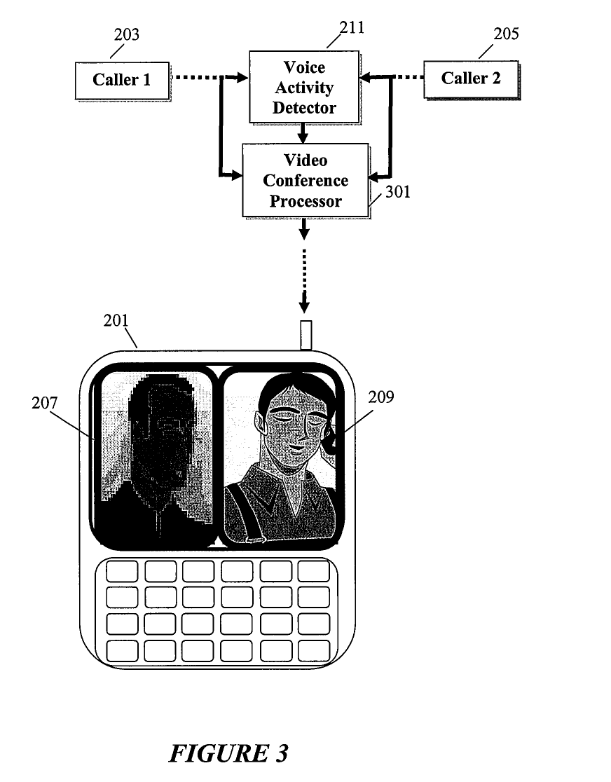

FIG. 3 is another illustration of an exemplary system for adapting video content in accordance with a representative embodiment of the present invention.

A video conference processor, 301, may be used for adapting a transmission of the video signals. While FIG. 2 illustrates that the user device, 201, may perform video processing, FIG. 3 illustrates that the video processing may also be performed prior to reception by the user device, 201. The video conference processor, 301, may apply different encoding rates to each video signal according to the audio strength comparison. Therefore, transmission bandwidth may be adapted and optimized.

The present invention applies to any purposeful selection of video enhancement or degradation for multiple feeds based on voice detection in a video conference. Aspects of the present invention may enhance video conferencing with any cellular or VoIP based product.

The present invention may be realized in hardware, software, or a combination of hardware and software. The present invention may be realized in a centralized fashion in an integrated circuit or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for adapting video, wherein the system comprises:
a voice activity detector for receiving a first audio signal and a second audio signal, wherein the voice activity detector compares the strengths of the first audio signal and the second audio signal, thereby creating an audio strength comparison; and
a video processing circuit for adapting one of a first video signal and a second video signal according to the audio strength comparison, wherein the first video signal is associated with the first audio signal and the second video signal is associated with the second audio signal.

2. The system of claim 1, wherein the first audio signal and the first video signal are associated with a first caller and the second audio signal and the second video signal are associated with a second caller.

3. The system of claim 2, wherein the audio strength comparison is a determination of whether the first caller or the second caller is a dominant speaker at a particular time.

4. The system of claim 3, wherein the first video signal is degraded if the second caller is the dominant speaker.

5. The system of claim 3, wherein a video signal not associated with the dominant speaker is degraded.

6. The system of claim 3, wherein a video signal associated with the dominant speaker is enhanced.

7. The system of claim 3, wherein a video signal associated with the dominant speaker is identified by a visual indicator.

8. The system of claim 1, wherein the video processing circuit is a video display engine.

9. The system of claim 8, wherein the video display engine enables a simultaneous display of the first video signal and the second video signal.

10. The system of claim 1, wherein the video processing circuit is a video conference processor for adapting a transmission of the first video signal and the second video signal.

11. The system of claim 10, wherein an encoding rate of the transmission is adapted according to the audio strength comparison.

12. A method for adapting video, wherein the method comprises:
receiving a first call having a first video component and a first audio component;
receiving a second call having a second video component and a second audio component;
comparing the first audio component with the second audio component, thereby providing an audio comparison; and
adapting one of the first video component and the second video component according to the audio comparison.

13. The method of claim 12, wherein the audio comparison is a determination of whether the first audio component or the second audio component indicates a dominant speaker.

14. The method of claim 13, wherein the first video component is visually degraded if the dominant speaker is on the second call.

15. The method of claim 13, wherein a video component not associated with the dominant speaker is visually degraded.

16. The method of claim 13, wherein a video component associated with the dominant speaker is visually enhanced.

17. The method of claim 13, wherein a video component associated with the dominant speaker is identified by a visual indicator.

18. The method of claim 12, wherein the method comprises displaying the first video component and the second video component.

19. The method of claim 12, wherein adapting comprises adapting an encoding rate of one of the first video component and the second video component.

20. The method of claim 19, wherein the method comprises encoding and transmitting the first video component and the second video component.
